(19) United States
(12) Patent Application Publication
(10) Pub. No.: US 2016/0203113 A1
(43) Pub. Date: Jul. 14, 2016

(54) Interactive Inline Frame and Webpage

(71) Applicants: Connor Francis Doherty, (US); David Michael Goligorsky, (US)

(72) Inventors: Connor Francis Doherty, (US); David Michael Goligorsky, (US)

(21) Appl. No.: 14/592,883

(22) Filed: Jan. 8, 2015

(51) Int. Cl. G06F 17/22; G06F 17/30; G06Q 30/02; G06F 17/21

(52) U.S. Cl. CPC G06F 17/2247; G06F 17/212; G06F 17/30896; G06Q 30/0277

(57) ABSTRACT

A system and method for interactive inline frames and webpages is described.

### CROSS REFERENCE TO RELATED APPLICATIONS

This application is a continuation of U.S. provisional patent application Ser. No. 62/068,646 entitled “Interactive inline Frame and Webpage”, Which was filed on Oct. 25, 2014 by the same inventor of this application and which is hereby incorporated by reference as if fully set forth herein.

### FIELD OF THE INVENTION

The invention relates generally to advertisements on a mobile device and more particularly but not exclusively to serving mobile advertisements within one or more inline frames (iframes) which take into consideration activity on the webpage on which the advertisement(s) is being served.

### BACKGROUND OF THE INVENTION

An iframe is essentially a nested webpage. It is a Hypertext Markup Language (HTML) document within another HTML document. In layman's terms, it allows a webpage or other content to be independently displayed within another webpage.

Conventional iframes provide content from a third party to be displayed on a webpage, independent of the content or activity on that webpage. An example of this is in the ad tech industry, where media (e.g. images and text) fill the iframe on a web page. The media, even if it may be rich media like video or animation, does not access user activity on the page to affect the way the user engages with this media. As a result, a consumer must elect to interact with the iframe content for the content to interact with the consumer.

It would thus be advantageous to create an iframe that allows the content to interact with the webpage on which it is embedded. It would be further advantageous to create such an iframe that enables the content on the iframe to perform one or more functions based on an activity performed on the webpage. It would be still further advantageous to provide such an iframe on a mobile device.

### BRIEF SUMMARY OF THE INVENTION

Many advantages of the invention will be determined and are attained by one or more embodiments of the invention, which in a broad sense provides an iframe that interacts with the webpage on which it is embedded and method for operating the same. In one or more embodiments code is placed on a webpage to create a conventional iframe. Additional code, which is entered onto the webpage, configures the webpage to send user. interaction data to the iframe. The iframe includes code which is configured to detect the incoming user interaction data and to perform a task related to the format and/or content of the iframe.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is an illustration of a webpage which includes an iframe and iframe content in accordance with one or more embodiments of the invention;

FIG. 2 is an illustration of the iframe and iframe content according to FIG. 1 in which the content of the iframe has changed as a result of some action taken on the webpage in which the iframe is embedded;

FIG. 3 is an illustration of an alternate embodiment of the iframe and iframe content according to FIG. 1;

FIG. 4 is an illustration of the iframe and iframe content according to FIG. 3 in which both the content and the iframe have changed as a result of some action taken on the webpage in which the iframe is embedded;

FIG. 5 is an illustration of the iframe according to FIG. 3 in which the iframe has changed orientation as a result of some action taken on the webpage in which the iframe is embedded; and,

FIG. 6 is an illustration of the iframe according to FIG. 3 in which the orientation and content have changed as a result of some action taken on the webpage in which the iframe is embedded.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

The invention relates generally to advertisements on a mobile device and more particularly but not exclusively to serving mobile advertisements within one or more inline frames (iframes) which take into consideration activity on the webpage on which the advertisement(s) is being served.

In this embodiment, an iframe is essentially a nested webpage. This version of the iframe is a Hyper text Markup Language (HTML) document within another HTML document. In layman's terms, it allows a webpage or other content to be independently displayed within another webpage.

Conventional iframes provide content from a third party to be displayed on a webpage, independent of the content or activity on that webpage. An example of this is in the advertising technology industry, where media (e.g. images and text) fill the iframe on a web page. The media, even if it may be rich media like video or animation, does not access user activity on the page to affect the way the user engages with this media. As a result, a consumer must elect to interact with the iframe content for the content to interact with the consumer.

It would thus be advantageous to create an iframe that allows the content to interact with the webpage on which it is embedded. It would be further advantageous to create such an iframe that enables the content on the iframe to perform one or more functions based on an activity performed on the webpage. It would be still further advantageous to provide such an iframe on a mobile device.

Many advantages of the invention will be determined and are attained by the invention, which in a broadest sense provides an iframe that interacts with the webpage on which it is embedded and method for operating the same. In one or more embodiments, code is placed on a webpage to create a conventional iframe, Additional code, which is entered onto the webpage, configures the webpage to send user interaction data to the iframe. The iframe, includes code which is configured to detect the incoming user interaction data and to perform a task related to the format and/or content of the iframe.

The invention will next be described in connection with certain illustrated embodiments and practices. However, it will be clear to those skilled in the art that various modifications, additions and subtractions can be made without departing from the spirit or scope of the claims.

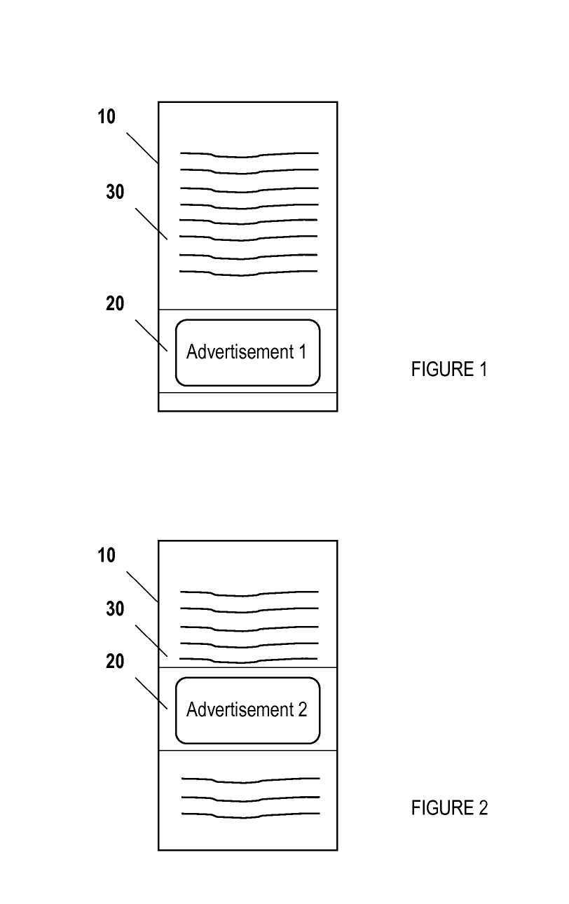

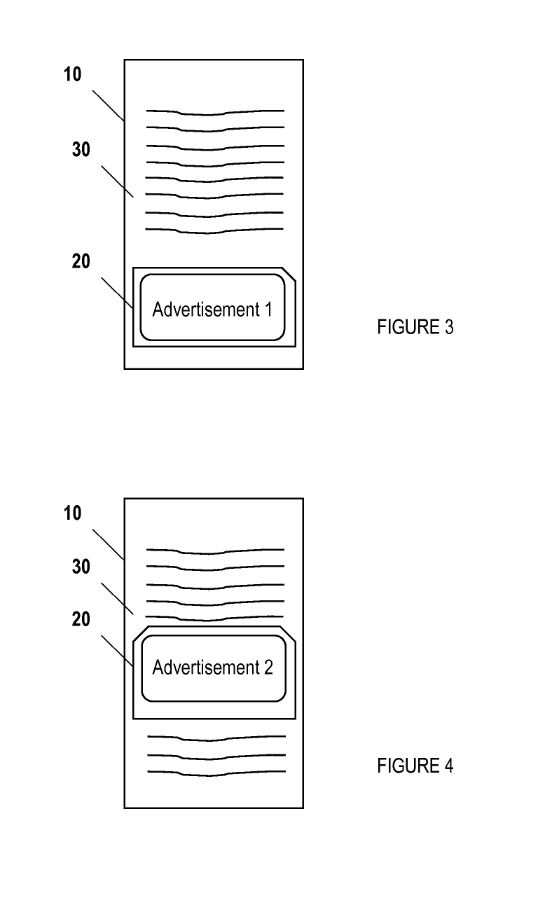

Referring to the drawings in detail wherein like reference numerals identify like elements throughout the various figures, there is illustrated in FIGS. 1-6, system and methods for creating an iframe which receives information from the webpage in which it is embedded and performs a task in response to at least a portion of the information. The following description is equally applicable to web pages displayed on a computer (e.g. a desktop or laptop device) and to those displayed on a mobile device (e.g. personal digital assistants (PDA), mobile phones, tablets, e-readers, portable game units, smart watches, etc.) however, the remainder of the description will focus on mobile devices. Those skilled in the art will recognize that even though the focus of the remaining description is on mobile devices the invention is not so limited.

FIG. 1 illustrates a mobile device 10, which is displaying the content of a webpage 30, or other content 30. Within webpage 30 is iframe 20 and within iframe 20 Advertisement 1 is being displayed. While an Advertisement 1 is being displayed, the invention is not so limited. The content of the iframe could be content other than an advertisement and still fall within a scope of the invention.

Adding a third party script or code to webpage 30 creates the iframe. This essentially creates an independent browser within webpage 30. The third party may then provide content (e.g. mobile advertisements, news articles, pictures, etc.) from a remote server for display on the iframe 20. Since those skilled in the art are familiar with the process and devices required to provide content from a remote location to the iframe 20, no further discussion of the same will be provided. In addition to the script required to create the iframe 20, additional code is inserted into the webpage 30 (either as part of the code that creates the iframe 20 or as separate code. The additional code is configured to detect/receive messages from the webpage 30 and forwards those messages to a corresponding script/code within the iframe 20. These messages are structured in a JSON (JavaScript Object Notation) object before they are stringified and sent using a W3C (World Wide Web Consortium) web standard for cross-document messaging known as postMessage. The script within the iframe 20 receives one or more messages from the additional script and performs an action as a result of at least a portion of the one or more messages.

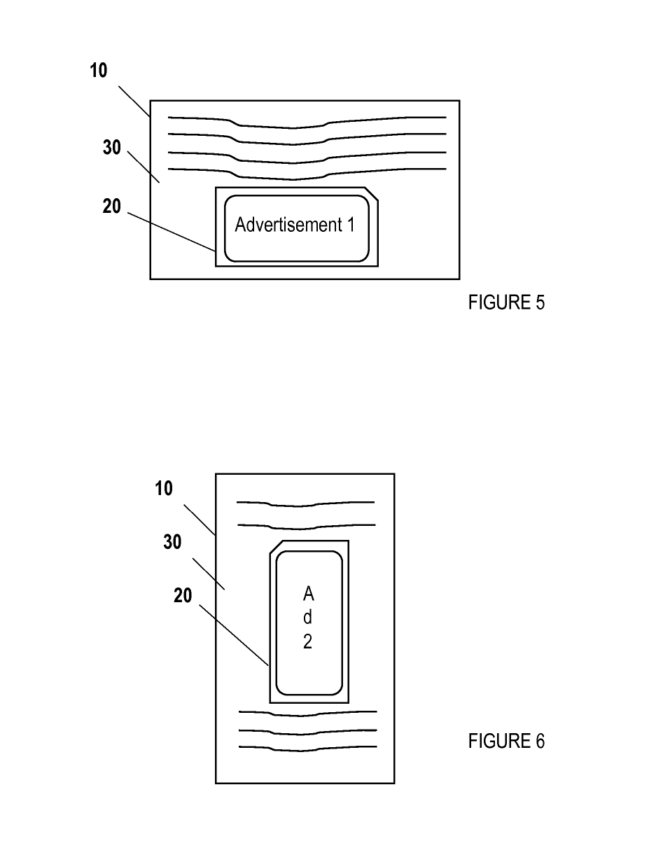

By way of some non-limiting examples as illustrated in FIGS. 1 and 2, the script within the iframe 20 receives one or more messages from the additional script which indicate(s) that the content on the webpage is scrolling from the position illustrated in FIG. 1 to the position illustrated in FIG. 2. As a result, the iframe script scrolls the iframe 20 as illustrated in FIG. 2. Alternatively or additionally, the iframe script could change the shape of the iframe as illustrated in FIG. 4, or could rotate the iframe 20 and the content thereof as illustrated in FIG. 6. By way of another non-limiting example, as illustrated in FIG. 5, the iframe script could receive a message indicating that the content of the webpage 30 is being rotated (e.g. as a result of the phone 10 being rotated) and could rotate the iframe 20 to match the rotation of the webpage content 30. In addition or alternatively to the above examples, the content provided to the iframe and/or displayed in the iframe could be altered based on activity in the webpage and/or the format of the content could be altered.

Those skilled in the art will recognize that the above examples are merely a very small sample of the possibilities provided by one or more embodiments of the invention. There are a multitude of possibilities that could he provided within a scope of the invention. For example, the iframe 20 is illustrated as a window within the webpage, however this is merely a design choice. The iframe could be designed in any number of shapes, and could include a border or no border.

Additionally, the iframe is illustrated as a single window, but those skilled in the art will recognize that it could be configured as multiple windows within the webpage each with the same shape, each with different shapes, some with the same shape and others with different shapes, all with borders, some with borders and/or some without or all without borders. As an action is detected on the webpage the shape and/or location of one or more of the iframe windows may change or remain stationary. As illustrated in FIGS. 1-4, the content within the iframe may change as a result of an action that takes place on the webpage or the content could remain the same within one or more iframe windows. For example, a new advertisement may be displayed, or if an advertiser wants to deliver an animated advertisement on a publisher page, the animation can be staged so that it starts when the advertisement enters the viewport of a mobile device and the animation could play forward and backward depending on the user scrolling in the viewport Or the animation/interactivity could be set to start when the advertisement is at the halfway point (or some other point) in the viewport. Additionally, the format of the content within one or more iframe windows may be determined and/or modified based upon information received from the webpage. By way of a non-limiting example, the color of the webpage could be used to determine the color(s) of the content within the iframe, and/or the style of the content may be determined and/or modified. Additionally, or alternatively, the styling information (CSS data) may be pulled to generate the styling of the promotion within the iframe.

Having thus described one embodiment of the invention, advantages can be appreciated. Variations from the described embodiments exist without departing from the scope of the invention.

Thus it is seen that system and method are provided for generating an iframe that utilizes actions taken Within the webpage in which the iframe is embedded to perform one or more actions. Although particular embodiments have been disclosed herein in detail, this has been done for purposes of illustration only, and is not intended to be limiting with respect to the scope of the claims, which follow. in particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may he any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also he supplied from a remote source embodied in a carrier medium such as an electronic signal, including a radio frequency carrier wave or an optical carrier wave.

In addition, various modifications and combinations of the illustrative embodiments as well as other embodiments of the invention will be apparent to persons skilled in the art upon reference to the description.

1-20. (canceled)

21. A system for serving content within a webpage, the system comprising:
a device accessing and displaying a webpage;
an iframe generated within said webpage on said device at a location within said webpage, wherein said iframe has a size and a shape;
a content received from a remote server, said content displayed at a location within said iframe; and
said location of said content scrolling within said iframe to another location within said iframe in response to a scrolling action performed on said webpage.

22. The system according to claim 21 where said content has a format; said content format changing in response to said action performed on said webpage.

23. The system according to claim 21 further comprising at least one of said iframe shape and size changing in response to said action performed on said webpage.

24. The system according to claim 23 where said content has a format; said content format changing in response to said action performed on said webpage.

25. The system according to claim 21 further comprising a content having different parts, a part of said content being displayed within said iframe; said part of said content being displayed within said iframe changing to another part of said content in response to said action performed on said webpage.

26. The system according to claim 21 wherein said content changing to different content in response to said scrolling action performed on said webpage.

27. (canceled)

28. (canceled)

29. The system according to claim 21 further comprising said iframe having an orientation relative to said device and said iframe rotating its orientation in response to said device rotating.

30. A method for creating an iframe within a webpage, the method comprising:
inserting iframe code within a webpage stored on a server;
said iframe code configured to generate said iframe;
inserting additional code within said webpage;
inserting interaction code within said iframe;
said webpage, iframe code, additional code and interaction code being accessed by a device remote from said server;
said device receiving a user interaction data indicating that a user interacts with said webpage;
said additional code receiving said user interaction data;
wherein said user interaction data indicates an action performed on said webpage;
said device receiving and displaying content from said remote server within said iframe;
said additional code forwarding said user interaction data to said interaction code within said iframe; and,
said interaction code within said iframe changing said displayed content within said iframe in response to receipt of said user interaction data.

31. The method according to claim 30 further comprising said content having a format; said interaction code changing said content format in response to receipt of said user interaction data.

32. The method according to claim 30 further comprising said iframe having a size and a shape; said iframe code changing at least one of said size and said shape in response to said action performed on said webpage.

33. The method according to claim 30 wherein said content is a video content having at least two stages and wherein said interaction code within said iframe replacing said content within said iframe with new content includes changing from a stage of said video to another stage of said video.

34. A system for serving content within a webpage, the system comprising:
a webpage stored on a server;
code entered into said webpage;
an iframe generated within said webpage by said code; and
a device remote from said server accessing said webpage and displaying an animated content within said iframe; said animated content including a plurality of stages;
said content changing from a displayed stage to another of said plurality of stages in response to an action performed on said webpage.

35. The system according to claim 34 wherein said another of said plurality of stages is sequentially after said displayed stage.

36. The system according to claim 34 wherein said another of said plurality of stages is sequentially before said displayed stage.

37. The system according to claim 34 wherein said iframe is generated and displayed on said device at a location within said webpage; and,
said location of said iframe within said webpage changing to another location within said webpage in response to said action performed on said webpage.
